(19) United States
(12) Patent Application Publication
(10) Pub. No.: US 2024/0426230 A1
(43) Pub. Date: Dec. 26, 2024

(54) METHODS AND APPARATUS FOR MANAGING FUEL IN OIL

(71) Applicant: JAGUAR LAND ROVER LIMITED, Warwickshire (GB)

(72) Inventors: Ed MIDDLETON, Whitley, Coventry, Warwickshire (GB); Gregory SHINE, Whitley, Coventry, Warwickshire (GB)

(21) Appl. No.: 18/701,307

(22) PCT Filed: Oct. 19, 2022
(86) PCT No.: PCT/EP2022/079076

§ 371 Date: Apr. 15, 2024

(30) Foreign Application Priority Data
Oct. 25, 2021 (GB) 2115305.1

(51) Int. Cl. F01M 11/10

(52) U.S. Cl. CPC F01M 11/10; F01M 2011/1466; F01M 2011/1473

(57) ABSTRACT

A method of managing fuel in oil 100 in an internal combustion engine of a hybrid electric vehicle, the method comprising: determining an amount of fuel flow into the engine oil during one or more cold start phases of engine operation 110; determining an amount of fuel evaporated from the engine oil during one or more phases of vehicle operation with the engine on 120; determining an amount of fuel evaporated from the engine oil during one or more phases of vehicle operation with the engine off 130; determining a percentage of fuel in the engine oil 140 from the amount of fuel flow into the engine oil and the amount of fuel flow evaporated from the engine oil; and modifying a service interval for the vehicle 150 based on the percentage of fuel in the engine oil.

### TECHNICAL FIELD

The present disclosure relates to methods and apparatus for managing fuel in oil, and particularly, but not exclusively, to methods and apparatus for managing fuel in oil in an internal combustion engine of a hybrid electric vehicle. Aspects of the invention relate to a method, to an apparatus, and to a vehicle.

### BACKGROUND

It is known that in internal combustion engines fuel may transfer from the cylinders of the engine into the engine oil during operation of the engine under certain conditions, for example when there is an improper fuel to air ratio. Fuel which is present in the engine oil can cause decreased viscosity and degradation of the oil, which may lead to increased component wear in the engine.

It is an aim of the present invention to address one or more of the disadvantages associated with the prior art.

### SUMMARY OF THE INVENTION

Aspects and embodiments of the invention provide a method, an apparatus, and a vehicle as claimed in the appended claims.

According to an aspect of the present invention there is provided a method of managing fuel in oil in an internal combustion engine of a hybrid electric vehicle, the method comprising: determining an amount of fuel flow into the engine oil during one or more cold start phases of engine operation; determining an amount of fuel evaporated from the engine oil during one or more phases of vehicle operation with the engine on; determining an amount of fuel evaporated from the engine oil during one or more phases of vehicle operation with the engine off; determining a percentage of fuel in the engine oil from the amount of fuel flow into the engine oil and the amount of fuel flow evaporated from the engine oil; and modifying a service interval for the vehicle based on the percentage of fuel in the engine oil.

An advantage of this aspect of the invention is that an accurate determination of the amount of fuel in engine oil can be made in order to ensure that engine oil changes are appropriately timed prior to the engine oil becoming too degraded, thereby ensuring optimal operation of the engine during its lifetime.

In the one or more cold start phases of engine operation, a proportion of fuel which is required to be injected into the engine, to start the engine, may enter into the engine oil.

The proportion of fuel which enters into the engine oil in the cold start phase of engine operation may be dependent upon the temperature of the engine oil.

More fuel may enter into the engine oil in the cold start phase of engine operation when the temperature of the engine oil is low compared to when the temperature of the engine oil is high.

The proportion of fuel which enters into the engine oil in the cold start phase of engine operation may be dependent upon engine torque produced by the engine.

More fuel may enter the engine oil in the cold start phase of engine operation when the engine torque is high compared to when the engine torque is low.

The proportion of fuel which enters into the engine oil in the cold start phase of engine operation may be dependent upon an engine configuration.

The proportion of fuel which enters into the engine oil in the cold start phase of engine operation may be dependent upon one or more of: a temperature of engine coolant in the cold start phase of engine operation; the ambient air pressure in the cold start phase of engine operation; the engine speed in the cold start phase of engine operation; and a total distance the vehicle has travelled.

Excess fuel is provided to the engine during a cold start phase of engine operation by applying a multiplicative correction factor, greater than 1, to the amount of fuel to be injected into the engine to achieve a target lambda value. This provides the advantage of ensuring correct operation of the engine during a cold start phase.

The amount of fuel flow into the engine oil during the one or more cold start phases of engine operation may be determined from a difference between the excess fuel provided to the engine and an amount of fuel that has been combusted which may be measured by a lambda sensor in an exhaust of the engine. This provides the advantage of providing data to manage fuel in oil in an engine.

The method may comprise determining an amount of fuel flow into the engine oil during one or more enrichment phases of engine operation where the engine may be operated at a high speed and high load that requires a target lambda value to be less than 1. This provides the advantage of providing data to manage fuel in oil in an engine.

During the one or more enrichment phases, additional fuel may be injected into the engine to reduce a temperature of one or more cylinders of the engine. This provides the advantage of limiting heat stress on components of the engine.

Additional fuel which may be injected into the engine during the one or more enrichment phases may also reduce a temperature of one or more of: an exhaust manifold; and a turbocharger of the engine. This provides the advantage of limiting heat stress on components of the engine.

The amount of fuel flow into the engine oil during the one or more enrichment phases may be determined from an exhaust soot mass flow rate which may be calculated from engine speed and load, where the exhaust soot mass flow rate may correlate to a rate of fuel flow into the engine oil during the one or more enrichment phases, the amount of fuel flow into the engine oil being calculated from the rate of fuel flow into the engine oil integrated over time.

The exhaust soot mass flow rate may be modified dependent on a temperature of the engine oil.

The exhaust soot mass flow rate may be modified dependent on an ambient air pressure.

The amount of fuel that has been determined to have entered the engine oil may be split by a configurable ratio into two separate components that represent a light mass fraction and a heavy mass fraction. The light mass fraction and heavy mass fraction may have distinctly different physical properties, for example different boiling points.

An amount of fuel evaporated from the engine oil during the one or more phases of vehicle operation with the engine on may be dependent on an engine oil temperature, where there may be a greater amount of fuel evaporated from the engine oil at a higher engine oil temperature than a lower engine oil temperature.

An amount of fuel evaporated from the engine oil during the one or more phases of vehicle operation with the engine on may be dependent on an engine speed, where there may be a greater amount of fuel evaporated from the engine oil at a higher engine speed than a lower engine speed.

An amount of fuel evaporated from the engine oil during the one or more phases of vehicle operation with the engine off may be dependent on an engine oil temperature, where there may be a greater amount of fuel evaporated from the engine oil at a higher engine oil temperature than a lower engine oil temperature. This provides the advantage of ensuring evaporation of fuel from the engine oil in an engine which has been operated continues to be accounted for after the engine is shut-off, thereby providing a more accurate estimate of overall fuel evaporation from the engine oil.

The amount of fuel evaporated from the engine oil may depend on the proportion of components in the fuel with a light mass and the proportion of components in the fuel with a heavy mass.

The amount of fuel evaporated from the engine oil may be calculated by integrating a rate of fuel evaporation from the engine oil over time.

Fuel evaporated from the engine oil may leave the engine via a crankcase ventilation system.

The crankcase ventilation system may comprise a valve to allow evaporated fuel to recirculate into an air intake of the engine to be combusted.

During one or more phases of vehicle operation with the engine on the valve may continuously allow the fuel evaporated from the engine oil to leave the engine, and during one or more phases of vehicle operation with the engine off the valve may close following engine shut-off whilst fuel continues to evaporate from the engine oil for a time period following engine shut-off.

The time period may be determined dependent upon the engine oil temperature at the time of engine shut-off.

When the valve is open, the rate of fuel evaporation from engine oil may be determined and the amount of fuel evaporation from the engine oil may be calculated by integrating the rate of fuel evaporation from engine oil over time.

The difference between the amount of fuel flow into the engine oil and the amount of fuel evaporated from the engine oil may provide a value for a mass of fuel in the engine oil, and the percentage of fuel in the engine oil may be determined from the mass of fuel in the engine oil as a percentage of a total mass of engine oil.

A modified service interval may be predicted dependent upon an estimation of the time or distance the vehicle can be driven until a predetermined percentage of fuel in oil is exceeded. This provides the advantage of optimising the oil change interval to ensure optimal operation of the engine.

The modified service interval may be output to a user display.

A standard service interval may be output to the user display if the modified service interval is greater than the standard service interval.

The modified service interval may reduce as the percentage of fuel in the engine oil increases.

The predetermined percentage of fuel in oil may be different for different engines and may be a value between, for example, 3% and 15% fuel in oil.

According to an aspect of the invention, there is provided an apparatus for managing fuel in oil in an engine of a hybrid electric vehicle, the apparatus comprising processing means configured to: determine an amount of fuel flow into the engine oil during one or more cold start phases of engine operation; determine an amount of fuel evaporated from the engine oil during one or more phases of vehicle operation with the engine on; determine an amount of fuel evaporated from the engine oil during one or more phases of vehicle operation with the engine off; determine a percentage of fuel in the engine oil from the amount of fuel flow into the engine oil and the amount of fuel flow evaporated from the engine oil; and modify a service interval for the vehicle based on the percentage of fuel in the engine oil.

According to an aspect of the invention, there is provided a vehicle comprising an apparatus according to any preceding aspect.

According to an aspect of the invention there is provided a computer program comprising instructions which, when the program is executed by processing means, cause the processing means to carry out the method of another aspect.

According to an aspect of the invention there is provided a non-transitory, computer-readable storage medium storing instructions thereon that when executed by processing means causes the processing means to carry out the method of another aspect.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a flow diagram of blocks of a method according to an embodiment of the invention;

FIG. 2 illustrates a schematic diagram of an apparatus for managing fuel in oil according to an embodiment of the invention; and

FIG. 3 illustrates a vehicle in accordance with an embodiment of the invention.

### DETAILED DESCRIPTION

Examples of the present disclosure relate to a method of managing fuel in oil in an internal combustion engine of a hybrid electric vehicle and apparatus for managing fuel in oil in an internal combustion engine of a hybrid electric vehicle. The term fuel in oil, in the embodiments described below, relates to fuel dilution in engine oil.

In particular, some examples of the present disclosure relate to a method of managing fuel in oil in an internal combustion engine of a hybrid electric vehicle by determining the fuel flow into and out of engine oil in a vehicle engine and apparatus for performing that method. The methods described herein are of particular relevance to hybrid electric vehicles as such vehicles can operate, that is be driven, without the engine being on, and the operation of the engine can be instigated by a user demanding acceleration of the vehicle, for example to overtake another vehicle, thereby requiring operation of the engine under potentially high load at cold temperatures. Non-limiting examples will now be described with reference to the accompanying drawings.

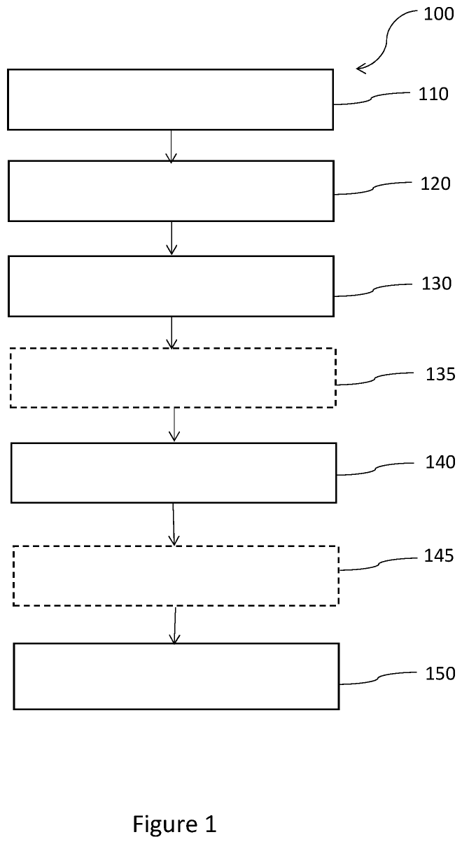

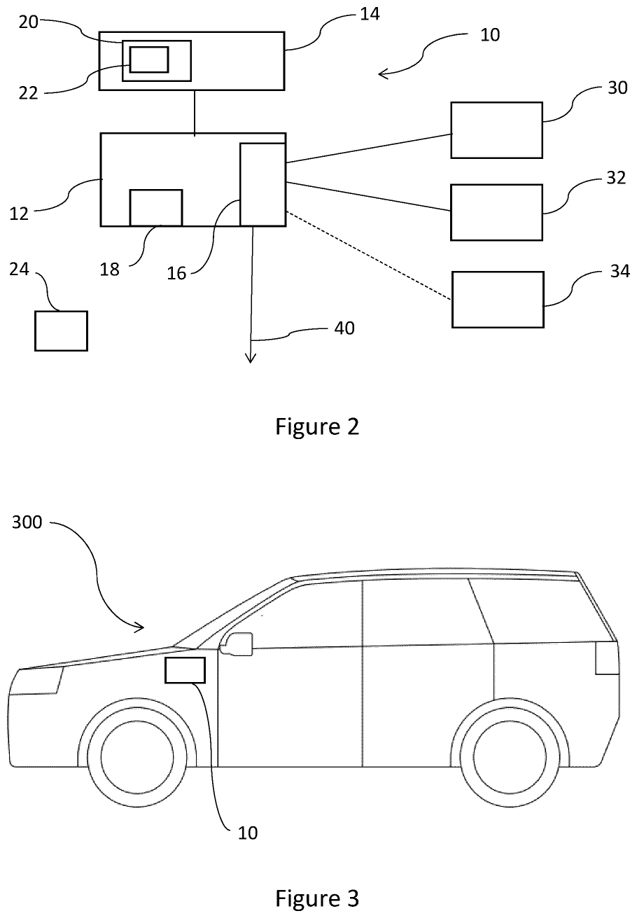

A method 100 of managing fuel in oil in an internal combustion engine of a hybrid electric vehicle in accordance with an embodiment of the present invention is described herein with reference to the accompanying FIG. 1. An apparatus 10 for managing fuel in oil according to an embodiment of the invention is described herein with reference to the accompanying FIG. 2. A vehicle 300 in accordance with an embodiment of the present invention is described herein with reference to accompanying FIG. 3.

FIG. 1 illustrates a flow chart of the blocks of a method 100 for managing fuel in oil in a hybrid electric vehicle 300. A hybrid electric vehicle 300 comprises both an internal combustion engine and electric propulsion means, such as an electric motor, which may sometimes be called a traction motor. The electric propulsion means may be powered by a battery, which may sometimes be called a traction battery. Such hybrid electric vehicles can be operated with the engine on, or the engine off, or in some circumstances with both the engine on and the electric motor on. When the engine is off, the electric propulsion means may solely operate to move the vehicle 300. Such a hybrid electric vehicle 300 may be arranged or configured to drive in a mode whereby only electric power is used to cause the vehicle 300 to move. Such a mode may be operable when a vehicle speed is below a certain threshold and/or the battery charge is above a certain threshold. In some vehicles electric only operation can be provided or selected by a user. Such an electric vehicle mode may be considered as a selectable electric vehicle (SEV) mode.

The method 100 of managing fuel in oil in an internal combustion engine of a hybrid electric vehicle 300 begins at block 110, where an amount of fuel flow into the engine oil during one or more cold start phases of engine operation is determined.

A cold start phase is an engine phase extending for a period of time from when the engine has been started until it reaches a normal operating temperature. The normal operating temperature is predefined for a particular engine. Such a phase of engine operation may start with the engine at ambient temperature, but not necessarily so. The engine may begin such a phase at a temperature between ambient temperature and the normal operating temperature. Such a period of time will vary depending on the starting temperature of the engine and ambient temperature, as well as other factors relating to engine efficiency. In hybrid electric vehicles operation of the engine can be intermittent during a journey, in other words, the engine may switch on and off depending on a driver torque demand and/or dependent on certain operating factors, such as the speed of the vehicle 300.

The normal operating temperature of an engine is often defined by the engine oil temperature which most commonly has a normal operating temperature in the region of 80° C. to 100° C. Higher engine oil temperature leads to higher oil oxidation, meaning that the engine oil will degrade more quickly requiring more frequent engine oil changes. Most vehicle engines have a standard operating temperature of 90° C., that is, a normal operating temperature for the engine oil of 90° C.

The fuel flow into the engine oil at a cold start phase is calculated by deducting a fuel quantity detected in the vehicle exhaust from an injected fuel quantity. That is, the net quantity of fuel entering the oil is estimated to be the missing quantity of injected fuel that has not been detected in the exhaust.

A combustion cycle takes place in the engine, and a complete combustion event takes place when all of the fuel is burned, such that in the exhaust gas there are no quantities of unburned fuel. The ideal air to fuel ratio for complete combustion is the stoichiometric air to fuel ratio. A ratio of the actual air to fuel ratio exhibited by the engine to the ideal air to fuel ratio is termed the lambda value, and is measured using a lambda sensor in the vehicle exhaust path. A lambda value of 1 indicates stoichiometric conditions where the mass of air is exactly the right amount to cause complete combustion, a lambda value less than 1 indicates a rich air to fuel mixture, where there is not enough air to completely burn the fuel, and a lambda value greater than 1 indicates a lean air to fuel mixture where there is more air than is required to completely burn the fuel. When lambda is less than 1 there will be unburnt fuel in the exhaust gases and when lambda is greater than 1 there will be excess oxygen in the exhaust gases.

The quantity of injected fuel may be known from the operation of the fuel injection system, which injects the desired amount of fuel into a pre-combustion chamber or a combustion chamber of the engine.

During a cold start phase, a greater amount of fuel is required to be injected than is required to be injected when the engine is at a normal operating temperature, since, during the cold start phase, some of the injected fuel contacts cold engine components and cannot then be combusted meaning that engine operation is sub-optimal.

During a start phase of the engine, the target lambda value may be 1 and excess fuel is provided by applying a multiplicative correction factor in the fuel injection strategy, such that the amount of fuel that will be combusted will lead to correct operation of the engine at during the start phase, that is, in order to achieve the target lambda value and therefore stable combustion. In some cold start phases, the target lambda value may be less than 1. In such circumstances the excess fuel provided to the engine will be increased.

During non-cold start phases the correction factor is 1, that is, during starting of the engine, when the engine is at an optimal operating temperature, the multiplicative correction factor is 1 such that no excess fuel is provided into the engine. During cold start phases the multiplicative correction factor will be greater than 1, such that excess fuel is provided into the engine. That is, the amount of fuel to be injected into the engine is increased by a multiple which is greater than 1. By this mechanism, the target lambda value of 1 can be achieved. The correction factor may be dependent on the temperature, with a lower temperature requiring a greater multiplicative correction factor.

The quantity of fuel that has been combusted is determined from measurements by the lambda sensor which measures the amount of oxygen in the exhaust gas. A voltage output of the lambda sensor can indicate whether, and how much, fuel is unburned.

The difference between the excess fuel injected and the amount of fuel that has been combusted can then be used to determine the amount of fuel that is assumed to have entered the engine oil. That is, the amount of fuel flow into the engine oil during the one or more cold start phases of engine operation is determined from a difference between the excess fuel provided to the engine and an amount of fuel that has been combusted which is measured using a lambda sensor in an exhaust of the engine.

In the one or more cold start phases of engine operation, a proportion of fuel which is required to be injected into the engine, to start the engine, and in some instances operate the engine for a period of time following start of the engine, may therefore enter or flow into the engine oil. This may occur as fuel may impinge on the cylinder walls of the engine and be transported into the engine oil during operation of the engine. For example, fuel may be dragged or scraped by piston rings and/or transported by blow-by forces into the engine oil during operation of the engine. The blow-by force mechanism is provided because high pressure inside the combustion chamber can lead to gasses escaping past the piston rings, those gasses transporting fuel into the engine oil.

Various parameters of, or relating to, the engine may affect the amount or proportion of fuel that may enter into the engine oil. For example, the proportion of fuel which enters into the engine oil in the cold start phase of engine operation may be dependent upon the temperature of the engine oil, wherein more fuel may enter into the engine oil in the cold start phase of engine operation when the temperature of the engine oil is low compared to when the temperature of the engine oil is high. The proportion of fuel which enters into the engine oil in the cold start phase of engine operation may be dependent upon the engine torque, that is, the torque produced by the engine, wherein more fuel may enter into the engine oil in the cold start phase of engine operation when the engine torque is high compared to when the engine torque is low.

In some embodiments the proportion of fuel which enters into the engine oil in the cold start phase of engine operation may be dependent upon a combination of the temperature of the engine oil and the engine torque. For example, more fuel may enter into the engine oil in the cold start phase of engine operation when the temperature of the engine oil is low and the engine torque is high compared to when the temperature of the engine oil is high and the engine torque is low.

Other parameters relating to the engine may affect the amount or proportion of fuel that may enter or flow into the engine oil in the cold start phase of engine operation, and these may include one or more of: an engine configuration; a temperature of engine coolant in the cold start phase of engine operation; the ambient air pressure in the cold start phase of engine operation; the engine speed in the cold start phase of engine operation; and a total distance the vehicle 300 has travelled. The engine configuration may depend on one or more features such as bore and stroke of the engine, piston displacement, engine displacement, compression ratio and thermal efficiency.

In some embodiments the proportion of fuel which enters into the engine oil in the cold start phase of engine operation may be dependent upon a combination of the temperature of the engine oil, the engine torque, and the engine configuration.

The determination of the total distance the vehicle 300 has travelled may be a value of distance travelled since the last engine oil change. Therefore, the value of total distance the vehicle 300 has travelled may compensate for the age of the engine oil in the engine and/or consumption of engine oil during operation of the vehicle 300 over the total distance travelled since the last oil change.

The determination of the total distance the vehicle 300 has travelled may be used to compensate for wear on the engine components which may lead to increased fuel entering the engine oil, however, rather than using a determination of a total distance the vehicle 300 has travelled, an engine wear parameter based on historic engine loads over periods of operation of the engine can be determined and used to compensate the amount or proportion of fuel that may have entered or flowed into the engine oil in the cold start phase of engine operation.

Therefore, engine wear parameters based on historic engine loads over periods of operation of the engine may be used in the calculation of the amount or proportion of fuel that may enter or flow into the engine oil in the cold start phase of engine operation.

Each of the parameters affecting the amount or proportion of fuel that may enter or flow into the engine oil may have a corresponding correction factor to be applied to the calculation of excess fuel that has been injected but not combusted, and therefore assumed to have entered the engine oil. The value resulting from the application of the correction factors to the calculation of assumed amount of fuel entering the engine oil is a compensated amount of fuel which is assumed to have entered the engine oil.

The fuel used in the operation of the internal combustion engine may comprise different components, each of which may have a different mass and different physical properties. The amount of fuel that has been determined to have entered the engine oil may be split by a configurable ratio into two separate components that represent a light mass fraction and a heavy mass fraction. The light mass fraction and heavy mass fraction may have distinctly different physical properties, for example different boiling points where heavy mass component may have a higher boiling point, requiring a higher temperature to enable evaporation. In some circumstances, normal operation of the engine may not provide sufficiently high temperatures to cause evaporation of the heavy mass fraction from the engine oil.

In some example fuels, the light mass fraction may represent 95% to 99% of the total mass of the fuel. As will be appreciated, there may be a large variation in the light and heavy mass fractions for different fuels and therefore this ratio may be configurable for any given fuel type.

At block 120 an amount of fuel evaporated from the engine oil during one or more phases of vehicle operation with the engine on is determined.

An amount of fuel which is evaporated from the engine oil during the one or more phases of vehicle operation with the engine on is dependent on an engine oil temperature. When the engine oil is above a threshold oil temperature, evaporation of the fuel from the engine oil will occur, or is considered to occur. The threshold oil temperature may be, for example 40° C., which temperature may be a vapour temperature of the fuel in the oil. There is only a minimal amount of fuel evaporation that occurs with engine oil temperatures at 40° C., and a relatively low amount of fuel evaporation that occurs between 40° C. and 60° C., with the amount of fuel evaporation increasing with increasing temperature. In this range of temperatures the overall fuel evaporation is not significant to the overall operation of the system. A significant amount of fuel evaporation may occur at and above 60° C. A greater amount of fuel is evaporated from the engine oil at a higher engine oil temperature than a lower engine oil temperature. That is, there is a higher rate of fuel evaporation at higher engine oil temperatures, relative to lower engine oil temperatures.

For example, the evaporation rate at 100° C. may be approximately four times greater than the evaporation rate at 60° C.

An amount of fuel which is evaporated from the engine oil during the one or more phases of vehicle operation with the engine on may be dependent on an engine speed. At higher engine speeds a greater amount of fuel evaporation from the engine oil occurs than at lower engine speeds.

In some embodiments the amount of fuel which is evaporated from the engine oil during the one or more phases of vehicle operation with the engine on may be dependent on both the engine oil temperature and the engine speed. In such an arrangement, there is a higher amount and/or rate of fuel evaporation at a higher engine oil temperature and engine speed compared to a lower engine oil temperature and engine speed.

The amount of fuel evaporated from the engine oil may also depend on the proportion of components in the fuel which have a light mass and the proportion of components in the fuel with a heavy mass. A fuel with a higher light mass fraction may exhibit greater fuel evaporation than a fuel with a lower light mass fraction for a give temperature of engine oil within which the fuel is located. Light mass components will evaporate more quickly than heavy mass components, and in some instances the heavy mass components may not reach an evaporation threshold temperature during normal operation of the engine and therefore may not be able to be evaporated from the engine oil.

At block 130 an amount of fuel evaporated from the engine oil during one or more phases of vehicle operation with the engine off is determined.

An amount of fuel which is evaporated from the engine oil during the one or more phases of vehicle operation with the engine off is dependent on an engine oil temperature. When the engine oil is above a threshold oil temperature, evaporation of the fuel from the engine oil will occur. A greater amount of fuel is evaporated from the engine oil at a higher engine oil temperature than a lower engine oil temperature.

Therefore, when the engine has been operating such that the engine oil temperature exceeds the threshold oil temperature, evaporation of the fuel from the engine oil will occur, or be considered to occur. Once the engine ceases to operate, or is put into an engine shut-off condition, whereby further heat from combustion events and component movement is not being generated, the engine oil begins to cool. As the engine oil cools, the rate of fuel evaporation from the engine oil slows until the engine oil temperature reaches the threshold oil temperature.

There can be many occurrences of engine shut-off events during a vehicle journey where the vehicle 300, such as a hybrid electric vehicle 300, will operate only using electric power, such as when the vehicle 300 slows to creep speeds, when the vehicle 300 stops, for example at road junctions or traffic lights, or if a demand for acceleration is removed, or significantly reduced, at low to medium speeds.

The amount of fuel evaporated from the engine oil may be calculated by integrating a rate of fuel evaporation from the engine oil over time. The rate of fuel evaporation at any given point in time is dependent on oil temperature, and engine speed if the engine is on, at that given point in time and can be a calibrated factor for an engine.

The fuel evaporated from the engine oil during engine operation may leave the engine via a crankcase ventilation system. The crankcase ventilation system allows evaporated fuel to recirculate into an air intake of the engine to be combusted. During one or more phases of vehicle operation with the engine on, the crankcase ventilation system continuously allows the fuel evaporated from the engine oil to leave the engine. When the engine is in a shut-off condition, the crankcase ventilation system does not allow the fuel evaporated from the engine oil to leave the engine. Following engine shut-off fuel may continue to evaporate from the engine oil, with the evaporated fuel occupying an air space within the engine crankcase. The amount of evaporated fuel occupying the engine crankcase following engine shut-off may be assumed to leave the engine at the next engine start.

In some embodiments, the crankcase ventilation system may comprise a valve. The valve may be spring operated and held open by pressure inside the crankcase during engine operation. During one or more phases of vehicle operation with the engine off, that is, in a shut-off condition, the valve closes whilst fuel continues to evaporate from the engine oil for a time period following engine shut-off. The fuel evaporated during this time period occupies a void in the engine crankcase. The time period may be determined dependent upon the engine oil temperature at the time of engine shut-off.

The time period may be mapped against engine oil temperature to provide a series of time period values. Alternatively, the time period may be determinable from an equation defining a relationship between engine oil temperature and the time period. At higher temperatures, the void in the engine crankcase will fill up with evaporated fuel faster than at lower temperatures and therefore the time period at higher engine oil temperatures will be shorter. The time delay provides a time for which fuel evaporation is continued to be calculated following engine shut off.

When the valve is open, the rate of fuel evaporation from the engine oil is determined and the amount of fuel evaporation from the engine oil is calculated by integrating the rate of fuel evaporation from the engine oil over time. The rate of fuel evaporation from the engine oil may be determined using one or more of knowledge of the temperature of the engine oil, the engine speed, and knowledge of the amount of fuel in the engine oil. The amount of fuel in the engine oil may be defined by a variable, to be varied dependent on the estimated fuel flow into the engine oil and estimated fuel flow out of the engine oil, as defined in the previous blocks of the method.

At block 140 a percentage of fuel in the engine oil is determined from the amount of fuel flow into the engine oil and the amount of fuel flow evaporated from the engine oil. The difference between the amount of fuel flow into the engine oil and the amount of fuel evaporated from the engine oil provides a value for a mass of fuel in the engine oil. The percentage of fuel in the engine oil is determined from the mass of fuel in the engine oil as a percentage of a total mass of engine oil.

In order to calculate the percentage of fuel in the engine oil the total amount of fuel in the engine oil is determined by subtracting the amount of fuel estimated to have evaporated from the engine oil from the amount of fuel estimated to have entered the engine oil, and the total amount of engine oil may be determined using, for example, an oil level sensor. Such an oil level sensor may be, for example, in the form of a Hall Effect sensor, an ultrasonic sensor or a float sensor. The amount of engine oil may be calculated using an engine oil consumption model, for example. The total amount of engine oil and the total amount of fuel in the engine oil can then be used to determine the total percentage of fuel in the engine oil.

Optionally, at block 135, prior to determining the percentage of fuel in the engine oil, an amount of fuel flow into the engine oil during one or more enrichment phases of engine operation may be determined, where the engine is operated at a high speed and high load that requires a target lambda value to be less than 1.

The determination of high speed engine operation depends on the engine to which the method is applied, and may, for example, be an engine speed above 4500 revolutions per minute. The determination of high load depends on the engine to which the method is applied, and may, for example, be a load greater than 60% of maximum engine torque output.

Such an enrichment phase may define component protection enrichment, where components of the engine can be protected from possible detrimental effects of running the engine at high speed and high loads, which may be especially prevalent in a hybrid electric vehicle 300, where the engine may be started whilst high loads are being demanded by the driver of the vehicle 300, such as in an overtaking manoeuvre when the vehicle 300 is already moving under electric only power, at or towards the limit of electric only power delivery.

During the one or more enrichment phases, additional fuel is injected into the engine to reduce a temperature of one or more cylinders of the engine. Since the combustion of the fuel is not stoichiometric due to the target lambda value being less than 1, there is excess fuel entering the cylinders which is then unburned. This excess unburned fuel vaporises on the cylinder walls and cools them which decreases the exhaust gas temperature. Some of this excess fuel may be transported into the engine oil during operation of the engine.

The additional fuel injected into the engine during the one or more enrichment phases may also reduce a temperature of one or more of: an exhaust manifold; and a turbocharger of the engine. Thus components of the engine can be protected in the enrichment phase by the cooling of the engine components through the introduction of excess fuel.

The amount of fuel flow into the engine oil during the one or more enrichment phases may be determined from an exhaust soot mass flow rate which is calculated from engine speed and engine load. An exhaust soot generation map can be defined in terms of the engine speed and engine load, and can be used to determine a base exhaust soot mass flow rate. A high exhaust soot mass flow rate is observed at the high engine speed and high engine load condition of the enrichment phase.

The exhaust soot mass flow rate correlates to a rate of fuel flow into the engine oil during the one or more enrichment phases, the amount of fuel flow into the engine oil being calculated from the rate of fuel flow into the engine oil integrated over time.

At block 150 a service interval for the vehicle 300 is modified based on the percentage of fuel in the engine oil. The service interval may define a time or distance to the next vehicle service, in particular, to the next oil change for the vehicle 300.

The service interval for the vehicle 300 may be modified dependent upon a current detected fuel in oil value for the engine oil. The service interval may be modified based, at least in part, upon a time since last oil change or distance travelled since last oil change. Such a modification can be automatically applied based on, at least, real time data relating to the current detected fuel in oil value for the engine oil determined using the above described method.

If the vehicle 300 has been subjected to frequent short journeys, leading to a high level of cold start phases, and/or has been subjected to frequent events requiring component protection enrichment, leading to a high level of enrichment phases, then the service interval may be shorter than if the vehicle 300 has not been subjected to, or has been subjected to few or infrequent, short journeys and/or has not been subjected to, or has been subjected to few or infrequent, events requiring component protection enrichment, since more oil will have entered into the engine oil during those cold start phases and enrichment phases. This may be offset or opposed by the operation of the engine for longer periods leading to more evaporation of fuel from the engine oil.

The modified service interval may be predicted dependent upon an estimation of the time or distance the vehicle 300 can be driven until a predetermined percentage of fuel in oil limit is exceeded.

In some embodiments, the modified service interval may be output to the user, for example on a user display in the vehicle 300. Where the modified service interval is greater than a standard service interval, the standard service interval may be output to the user display. In alternative embodiments, the modified service interval may be output to the user, for example on the user display in the vehicle 300, even if it exceeds the standard service interval. This allows for extending the service interval in certain circumstances.

The modified service interval may therefore reduce as the percentage of fuel in the engine oil increases. The predetermined percentage of fuel in oil limit, where it is determined that an oil change is required, is a value between 3% and 15% fuel in oil. In one example the predetermined percentage of fuel in oil limit is 10%.

Optionally, at block 145, a prediction of when the predetermined percentage fuel in oil limit will be exceeded can be made based on the historic data relating to the number of and frequency of cold start phases and/or enrichment phases leading to fuel flowing into the engine oil, and historic data relating to any longer periods of engine operation leading to fuel evaporation, both with the engine on and engine off. This prediction is then used to determine the modified service interval.

The service interval for the vehicle 300 may be modified dependent upon a current detected fuel in oil value for the engine oil and an estimated time to exceed a fuel in oil limit which may be, at least in part, dependent upon historical driving behaviour or driving style.

Using historic data relating to the number of, and frequency of, cold start phases and/or enrichment phases leading to fuel flowing into the engine oil, and historic data relating to any longer periods of engine operation leading to fuel evaporation, the service interval can be modified to provide an expected time to service, that is, a time when the engine oil is required to be changed.

The modified service interval may be predicted dependent upon an estimation of the time or distance the vehicle 300 can be driven until a predetermined percentage of fuel in oil limit is exceeded, based on the historic data.

FIG. 2 illustrates an apparatus 10 for managing fuel in oil in an engine of a hybrid electric vehicle 300, and FIG. 3 illustrates a vehicle 300 comprising an apparatus 10 for managing fuel in oil in an engine of a hybrid electric vehicle 300. The apparatus 10 comprises processing means 12, which may be in the form of, or comprise, a processor or processing circuitry, which is operable to carry out the blocks of the method as previously described, and may form part of one or more systems comprised in a vehicle 300. The processing means 12 may be implemented in hardware alone, have certain aspects in software including firmware alone or can be a combination of hardware and software (including firmware). The processing means 12 may be implemented using instructions that enable hardware functionality, for example, by using executable instructions of a computer program 20 in a general-purpose or special-purpose processing means 12 that may be stored on a computer readable storage medium (disk, memory etc.) to be executed by such a processing means 12.

The processing means 12 is configured to read from and write to storage means 14. The processing means 12 may also comprise an output interface 16 via which data and/or commands are output by the processing means 12. The processing means 12 may also comprise an input interface 18 via which data and/or commands are input to the processing means 12. For example, data relating to the mass of engine oil, lambda sensor measurements, and fuel injection amounts, amongst other data, may be received at the input interface 18.

The processing means 12 may be coupled to storage means 14, which may be in the form of a volatile or a non-volatile memory, which is arranged or configured to store the operations of the method for execution by the processing means 12, and also to store data relating to the method as herein described.

Where engine wear parameters are based on historic engine loads over periods of operation of the engine, those engine wear parameters may be stored in the storage means 14 for use by the processing means 12 in the calculation of the amount or proportion of fuel that may enter or flow into the engine oil in the cold start phase of engine operation.

The amount of fuel in the engine oil may be stored as a variable in the storage means 14 on the vehicle 300, to be varied dependent on the estimated fuel flow into and out of the engine oil as defined in the above blocks of the method.

Look up tables for the correction of exhaust soot mass flow rate based on one or more of the temperature of the engine oil and the ambient air pressure can be stored in the storage means 14, for recall when calculating the exhaust soot mass flow rate for the determination of the fuel flow into the engine oil during the one or more enrichment phases.

Historic data relating to the number of and frequency of cold start phases and/or enrichment phases leading to fuel flowing into the engine oil, and historic data relating to any longer periods of engine operation leading to fuel evaporation, both with the engine on and engine off, may be stored in the storage means 14 and used by the processing means 12 in the prediction of when the predetermined percentage fuel in oil limit will be exceeded.

The storage means 14 stores a computer program 20 comprising computer program instructions 22 (computer program code) for carrying out the above described method, and may output information or control one or more vehicle functions when loaded into the processing means 12. The computer program instructions 22, of the computer program 20, provide the logic and routines that enables the apparatus 10 to perform the methods illustrated in FIG. 1 and/or described herein. The processing means 12, by reading the storage means 14, is able to load and execute the computer program 20.

The apparatus 10 therefore comprises: at least one processing means 12; and at least one storage means 14 including computer program code, the at least one storage means 14 and the computer program code configured to, with the at least one processing means 12, cause the processing means 12 to: determine an amount of fuel flow into the engine oil during one or more cold start phases of engine operation; determine an amount of fuel evaporated from the engine oil during one or more phases of vehicle operation with the engine on; determine an amount of fuel evaporated from the engine oil during one or more phases of vehicle operation with the engine off; determine a percentage of fuel in the engine oil from the amount of fuel flow into the engine oil and the amount of fuel flow evaporated from the engine oil; and modify a service interval for the vehicle 300 based on the percentage of fuel in the engine oil.

The computer program 20 may arrive at the apparatus 10 via any suitable delivery mechanism 24. The delivery mechanism 24 may be, for example, a non-transitory computer-readable storage medium, a computer program product, a memory device, a record medium such as a compact disc read-only memory (CD-ROM) or digital versatile disc (DVD), or an article of manufacture that tangibly embodies the computer program 20. The delivery mechanism 24 may be a signal configured to reliably transfer the computer program 20.

In some embodiments, the apparatus 10 may further comprise one or more user interface, which may be in the form of display means 30, for example a visual user display or an instrument cluster of the vehicle 300, which may provide a visual indication relating to the status of the engine with regards to a fuel in oil value, and/or be in the form of an auditory interface 32 where a user of the vehicle 300 may be alerted by audible warnings relating to the status of the engine with regards to a fuel in oil value.

Such a status of the engine may relate to a service interval for the vehicle 300 which is dynamically affected by the fuel in oil ratio for the engine oil. For example, the time to next vehicle service can be displayed to a user of the vehicle 300 on a user display 30 and/or given as an audible signal to the user of the vehicle 300 through an auditory interface 32, such that it can be ensured that the engine oil can be changed at an appropriate time. In some embodiments the apparatus 10 may additionally or alternatively communicate with a user interface which is external to the vehicle 300 to provide information, relating to the fuel in oil ratio for the engine oil, to a user, for example through an application on a mobile device 34.

The service interval for the vehicle 300 may be modified dependent upon the current detected fuel in oil value for the engine oil and/or an estimated time to exceed a fuel in oil limit which may be, at least in part, dependent upon historical driving behaviour or driving style, as previously described.

Although the storage means 14 is illustrated as a single component/circuitry it may be implemented as one or more separate components/circuitry some or all of which may be integrated/removable and/or may provide permanent/semi-permanent/dynamic/cached storage.

Although the processing means 12 is illustrated as a single component/circuitry it may be implemented as one or more separate components/circuitry some or all of which may be integrated/removable. The processing means 12 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The blocks illustrated in FIG. 1 may represent steps in a method and/or sections of code in the computer program 20. The illustration of a particular order to the blocks does not necessarily imply that there is a required or preferred order for the blocks and the order and arrangement of the block may be varied. Furthermore, it may be possible for some blocks to be omitted. For example blocks 135 and 145 could be omitted, and blocks 110, 120, 130, and 135 may be implemented in any order.

It will be appreciated that various changes and modifications can be made to the present invention without departing from the scope of the present application.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-20. (canceled)

21. A method of managing fuel in oil in an internal combustion engine of a hybrid electric vehicle, the method comprising:
determining an amount of fuel flow into the engine oil during one or more cold start phases of engine operation;
determining an amount of fuel evaporated from the engine oil during one or more phases of vehicle operation with the engine on;
determining an amount of fuel evaporated from the engine oil during one or more phases of vehicle operation with the engine off;
determining a percentage of fuel in the engine oil from the amount of fuel flow into the engine oil and the amount of fuel flow evaporated from the engine oil; and
modifying a service interval for the vehicle based on the percentage of fuel in the engine oil.

22. A method of managing fuel in oil in an engine of a hybrid electric vehicle according to claim 21, wherein, in the one or more cold start phases of engine operation, a proportion of fuel which is required to be injected into the engine, to start the engine, enters into the engine oil.

23. A method of managing fuel in oil in an engine of a hybrid electric vehicle according to claim 22, wherein the proportion of fuel which enters into the engine oil in the cold start phase of engine operation is dependent upon the temperature of the engine oil, wherein more fuel enters into the engine oil in the cold start phase of engine operation when the temperature of the engine oil is low compared to when the temperature of the engine oil is high.

24. A method of managing fuel in oil in an engine of a hybrid electric vehicle according to claim 23, wherein the proportion of fuel which enters into the engine oil in the cold start phase of engine operation is dependent upon the engine torque produced by the engine, optionally further dependent upon an engine configuration, wherein more fuel enters into the engine oil in the cold start phase of engine operation when the engine torque is high compared to when the engine torque is low.

25. A method of managing fuel in oil in an engine of a hybrid electric vehicle according to claim 22, wherein the proportion of fuel which enters into the engine oil in the cold start phase of engine operation is dependent upon one or more of: a temperature of engine coolant in the cold start phase of engine operation; the ambient air pressure in the cold start phase of engine operation; the engine speed in the cold start phase of engine operation; and a total distance the vehicle has travelled.

26. A method of managing fuel in oil in an engine of a hybrid electric vehicle according to claim 22, wherein excess fuel is provided to the engine during a cold start phase of engine operation by applying a multiplicative correction factor, greater than 1, to the amount of fuel to be injected into the engine to achieve a target lambda value.

27. A method of managing fuel in oil in an engine of a hybrid electric vehicle according to claim 26, wherein the amount of fuel flow into the engine oil during the one or more cold start phases of engine operation is determined from a difference between the excess fuel provided to the engine and an amount of fuel that has been combusted which is measured by a lambda sensor in an exhaust of the engine.

28. A method of managing fuel in oil in an engine of a hybrid electric vehicle according to claim 21, the method comprising:
determining an amount of fuel flow into the engine oil during one or more enrichment phases of engine operation where the engine is operated at a high speed and high load that requires a target lambda value to be less than 1, optionally wherein, during the one or more enrichment phases, additional fuel is injected into the engine to reduce a temperature of one or more cylinders of the engine, optionally wherein the additional fuel injected into the engine during the one or more enrichment phases reduces a temperature of one or more of: an exhaust manifold; and a turbocharger of the engine.

29. A method of managing fuel in oil in an engine of a hybrid electric vehicle according to claim 28, wherein the amount of fuel flow into the engine oil during the one or more enrichment phases is determined from an exhaust soot mass flow rate which is calculated from engine speed and load, where the exhaust soot mass flow rate correlates to a rate of fuel flow into the engine oil during the one or more enrichment phases, the amount of fuel flow into the engine oil being calculated from the rate of fuel flow into the engine oil integrated over time, optionally wherein the exhaust soot mass flow rate is modified dependent on a temperature of the engine oil, optionally wherein the exhaust soot mass flow rate is modified dependent on an ambient air pressure.

30. A method of managing fuel in oil in an engine of a hybrid electric vehicle according to claim 21, wherein the amount of fuel that has been determined to have entered the engine oil may be split by a configurable ratio into two separate components that represent a light mass fraction and a heavy mass fraction each having distinctly different physical properties.

31. A method of managing fuel in oil in an engine of a hybrid electric vehicle according to claim 21, wherein an amount of fuel evaporated from the engine oil during the one or more phases of vehicle operation with the engine on is dependent on an engine oil temperature, where there is a greater amount of fuel evaporated from the engine oil at a higher engine oil temperature than a lower engine oil temperature, optionally wherein the amount of fuel evaporated from the engine oil during the one or more phases of vehicle operation with the engine on is dependent on an engine speed, where there is a greater amount of fuel evaporated from the engine oil at a higher engine speed than a lower engine speed.

32. A method of managing fuel in oil in an engine of a hybrid electric vehicle according to claim 21, wherein an amount of fuel evaporated from the engine oil during the one or more phases of vehicle operation with the engine off is dependent on an engine oil temperature, where there is a greater amount of fuel evaporated from the engine oil at a higher engine oil temperature than a lower engine oil temperature, optionally wherein the amount of fuel evaporated from the engine oil may depend on the proportion of components in the fuel with a light mass and the proportion of components in the fuel with a heavy mass.

33. A method of managing fuel in oil in an engine of a hybrid electric vehicle according to claim 31, wherein the amount of fuel evaporated from the engine oil is calculated by integrating a rate of fuel evaporation from the engine oil over time.

34. A method of managing fuel in oil in an engine of a hybrid electric vehicle according to claim 31, wherein fuel evaporated from the engine oil leaves the engine via a crankcase ventilation system.

35. A method of managing fuel in oil in an engine of a hybrid electric vehicle according to claim 34, wherein the crankcase ventilation system comprises a valve to allow evaporated fuel to recirculate into an air intake of the engine to be combusted, wherein during one or more phases of vehicle operation with the engine on the valve continuously allows the fuel evaporated from the engine oil to leave the engine, and during one or more phases of vehicle operation with the engine off the valve closes following engine shut-off whilst fuel continues to evaporate from the engine oil for a time period following engine shut-off, wherein the time period is determined dependent upon the engine oil temperature at the time of engine shut-off.

36. A method of managing fuel in oil in an engine of a hybrid electric vehicle according to claims 35, wherein, when the valve is open, the rate of fuel evaporation from engine oil is determined and the amount of fuel evaporation from the engine oil is calculated by integrating the rate of fuel evaporation from engine oil over time.

37. A method of managing fuel in oil in an engine of a hybrid electric vehicle according to claim 21, wherein the difference between the amount of fuel flow into the engine oil and the amount of fuel evaporated from the engine oil provides a value for a mass of fuel in the engine oil, and wherein the percentage of fuel in the engine oil is determined from the mass of fuel in the engine oil as a percentage of a total mass of engine oil.

38. A method of managing fuel in oil in an engine of a hybrid electric vehicle according to claim 21, wherein a modified service interval is predicted dependent upon an estimation of the time or distance the vehicle can be driven until a predetermined percentage of fuel in oil is exceeded, wherein the modified service interval is output to a user display, optionally wherein a standard service interval is output to the user display if the modified service interval is greater than the standard service interval, optionally wherein the modified service interval reduces as the percentage of fuel in the engine oil increases, optionally wherein the predetermined percentage of fuel in oil is a value between 3% and 15% fuel in oil.

39. An apparatus for managing fuel in oil in an engine of a hybrid electric vehicle, the apparatus comprising processing means configured to:
determine an amount of fuel flow into the engine oil during one or more cold start phases of engine operation;
determine an amount of fuel evaporated from the engine oil during one or more phases of vehicle operation with the engine on;
determine an amount of fuel evaporated from the engine oil during one or more phases of vehicle operation with the engine off;
determine a percentage of fuel in the engine oil from the amount of fuel flow into the engine oil and the amount of fuel flow evaporated from the engine oil; and
modify a service interval for the vehicle based on the percentage of fuel in the engine oil.

40. A vehicle comprising an apparatus according to claim 39.
